(19) United States
(12) Patent Application Publication
(10) Pub. No.: US 2009/0106275 A1
(43) Pub. Date: Apr. 23, 2009

(54) Method and system for screening items for transport

(76) Inventor: Liyun Zhang, Sunnyvale, CA (US)

Correspondence Address: D. James Chung;Suite 300, 100 Corson Street, Pasadena, CA, 91103, US

(21) Appl. No.: 11/975,837

(22) Filed: Oct. 22, 2007

(51) Int. Cl. G06F 17/30

(52) U.S. Cl. 707/100; 707/E17.001

(57) ABSTRACT

A method and a system for screening items for transport are disclosed. A passenger information database is provided, the passenger information database including a first passenger data record associated with the first passenger, the first passenger data record including an item list. The item list is populated by obtaining, from the first passenger, a list of items for transport. Access to the list of items is provided to security officer. A knowledge base having transport limitation for a plurality of items is provided. Using the knowledge base, for each item of the list of items, transport limitation of the item is determined. The security officer is notified with the item transport limitation.

### BACKGROUND

The present invention relates to a method and system of screening articles, for example articles of baggage or packages, that may be used, for example, in airports and other travel ports and shipping ports.

Due to various social and political forces and events, it appears that, for travel, the screening and security processes for boarding airplanes is likely to become increasingly intrusive and complex. This is due, in part, to counter increasingly sophisticated and knowledgeable terrorists and criminals who may scheme attacks or other malfeasance to the society.

To thwart such schemes, various scanning techniques and screening procedures have been implemented at airports and other travel locations. These include, for example, X-ray scanning of luggage and manual search of carry-on bags. It may be possible to thoroughly search every passenger; however, given a large number of flights, tight schedules, and a large number of passengers, this would be expensive and impractical.

Further, even when everyone is searched, not all potential dangers and contingencies may be detected or discovered. This is because, for example, the security officer performing the screening is not likely to have or memorize the exhaustive list of all possible items or combination of items that may lead to or have undesired properties or potentially destructive uses. Moreover, X-ray scanning or other technology scanning methods are not likely lead to recognition of all possible item or combination of items that may lead to or have undesired properties or potentially destructive uses.

It is possible that multiple terrorists or criminals cooperate to board a plane carrying items that are, considered individually, harmless but can be combined or assembled to form a dangerous composite. Such combinations or even the possibility of such combinations may not be detected by security officer. In addition, there is no way for a passenger to know, in advance of the flight, whether he or she is permitted to carry-on the items that he or she may desire to carry. For convenience, in this document, the masculine form of personal pronouns will be used, generically, to refer to a person where, in fact, the person may be a man or a woman.

Accordingly, there remains a need for an improved screening method and system to alleviate or eliminate these shortcomings, to increase security of travel, or both.

### SUMMARY

The need is met by the present invention. In a first embodiment of the present invention, a method for screening items for transport is disclosed. In this method, firstly, a passenger information database is provided, the passenger information database including a first passenger data record associated with the first passenger, the first passenger data record including an item list. The item list is populated by obtaining, from the first passenger, a list of items for transport. Access to the list of items is provided to security officer. A knowledge base having transport limitation for a plurality of items is provided. Using the knowledge base, for each item of the list of items, transport limitation of the item is determined. The security officer is notified with the item transport limitation.

The transport limitation can be determined while the passenger is updating the passenger item list. In this case, the passenger is notified with the item transport limitation. The item list can be implemented as a passenger item list editable by the first passenger and a security item list (initially a copy of the passenger item list) editable by a security officer. A computerized interface is provided to the first passenger to allow the first passenger officer to perform at least one of the following functions: add items, deleted items, and edit items. A computerized interface is provided to the security officer to allow the security officer to perform at least one of the following functions: add items, deleted items, and edit items.

The knowledge base includes a plurality of tables, each table having a plurality of entries. At least one table has at least one entry corresponding to at least one aspect of an item of the item list. Entries of the tables of the knowledge base having associations with entries of other tables of the knowledge base, the associations forming a network of associations.

To determining transport limitation of the item a number of operations are performed. First, the knowledge base is searched to identify at least one entry in the knowledge base that corresponds to at least one aspect of the item. Next, the network of associations is traversed beginning at the identified entry until an entry in a limitation table is reached. The limitation table is at least one of Carry-on Limitation Table and Checked Baggage Limitation Table. Finally, a decision is made whether or not the limitation of the reached entry of the limitation table is satisfied.

In a second embodiment of the present invention, a system for screening items for transport is disclosed. The system includes a server including storage, the storing having a passenger information database including a first passenger data record associated with the first passenger, the first passenger data record including an item list. The storage further includes a knowledge base having transport limitation for a plurality of items. The system further includes a security station for screening the first passenger, the security station connected to the server. The server is connected to an external network thereby allowing access to its passenger information database to the first passenger, also connected to the external network.

The system may include a kiosk terminal connected to the server, the kiosk terminal allowing the first passenger to access the item list. The knowledge base includes a plurality of tables, each table having a plurality of entries. At least one table has at least one entry corresponding to at least one aspect of an item of the item list. Entries of the tables of the knowledge base have associations with entries of other tables of the knowledge base, the associations forming a network of associations. The knowledge base includes a limitation table, where the limitation table is at least one of Carry-on Limitation Table and Checked Baggage Limitation Table. In the system the passenger information database may include multiple data tables, a first data table including a list of items editable by the first passenger and a second data table editable by a security officer.

In a third embodiment of the present invention, a method for screening items for transport is disclosed. First, a computerized interface is provided to a first passenger. Via the interface, the first passenger is prompted for input of items that the first passenger desires to carry onto the transport vehicle. Then, description of at least one item is obtained. Using the description, a list of items is formed, the list including descriptions of the obtained item. For each obtained item, transport limitation is determined then displayed for the first passenger. Via the interface, the first passenger is allowed to perform, on the list of items, at least one of the following functions: add item, deleted item, and edit item.

### BRIEF DESCRIPTION OF THE DRAWINGS

FIG. 1A is a flowchart illustrating a method for screening items for transport;

FIG. 1B is a flowchart illustrating an aspect of a method for screening items for transport;

FIG. 2 is a diagram illustrating a system for screening items for transport;

FIG. 3 illustrates storage portions of the system of FIG. 2 in more detail;

FIGS. 4A and 4B illustrate the storage portion of the system of FIGS. 2 and 3 in more detail; and

FIGS. 5A, 5B, and 5C illustrate additional portions of the storage of the system of FIG. 2 in more detail.

### DETAILED DESCRIPTION

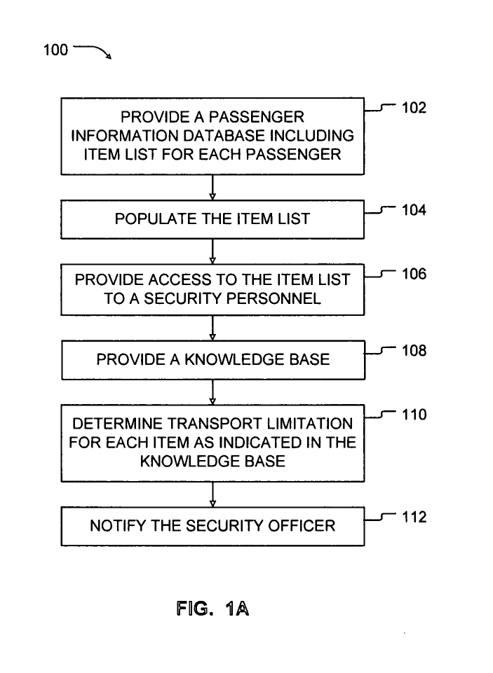

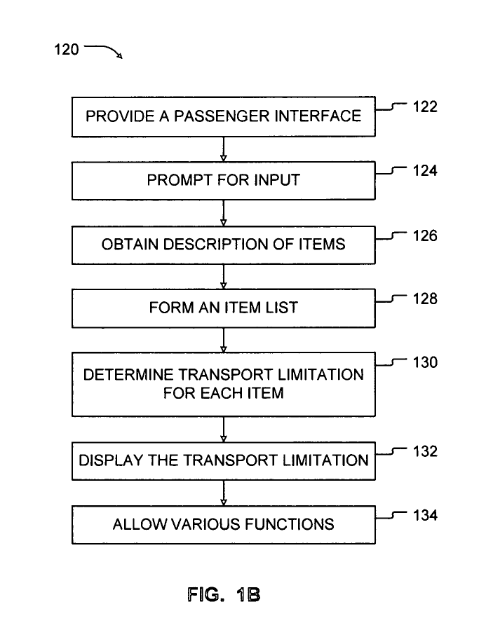

The present invention will now be described with reference to the FIGS. 1A through 5C which illustrate various aspects, embodiments, or implementations of the present invention. In the Figures, some sizes of structures, portions, or elements may be exaggerated relative to sizes of other structures, portions, or elements for illustrative purposes and, thus, are provided to aid in the illustration and the disclosure of the present invention.

The present invention provides methods and systems that can be used to obtain, before a flight takes place, contents of checked-in and carry-on luggage for each passenger of the flight. By obtaining the contents (represented as lists of items for “item lists”) of the passengers luggage before the flight, the efficiency of security screening process at the airport is increased. Further, the item lists can be analyzed before the flight and even before the passenger is screened by a security officer. During the analysis, any and all items or combination of items that can pose danger or potentially create dangerous situation to the transport vehicle are identified. Then, the identified items can be removed before the flight.

As shown in the drawings, one embodiment of the present invention is embodied in a method for screening items for transport. To screen the items, a passenger information database is provided. The passenger information database includes a first passenger data record associated with the first passenger, the first passenger data record including an item list. The item list is populating by obtaining, from the first passenger, a list of items for transport. Access to the item list is provided to a security officer who will be screening the first passenger prior to the flight. A knowledge base is provided, the knowledge base having transport limitation for a plurality of items and combination of items. That is, the knowledge base includes information to determine whether or not an item or a combination of items is allowed to be transported by the flight. Then, for each item of the item list, a determination is made, using the knowledge case, of transport limitation of each item of the item list. Finally, the security officer is notified of the transport limitation of each item.

The present invention results in a number of advantages over the present systems. For example, because the item list is available before the passenger even arrives at the airport, the passenger can be notified of any transport limitations of the items that he plans to check-in or carry-on to the airplane. Accordingly, the passenger can decide, before coming to the airport, whether or not to bring a particular item to the airport. For items prohibited to be transported, the passenger can avoid having such items confiscated by transport authorities. Secondly, because the item list is available before the passenger even arrives at the airport, analysis of the items and the transport limitation of the items can be performed before the arrival of the passenger at a security screening station. At the security screening station, the results of the analysis of the items and the transport limitation of the items are available to the security officer. This makes the work of the security officer easier and quicker, increasing qualitative efficiency and the speed in which the passenger is screened. Finally, because each and every passenger of the flight is associated with his item list, and all these items lists are available for analysis, combination of items that pose danger to the flight can be identified even when each item of the identified combination, alone, would not have posed danger to the flight. That is, in cases where multiple terrorists or criminals cooperate to board a plane carrying items (articles or chemicals that are harmless by themselves) that can be combined or assembled to form a dangerous combination, such combinations or even the possibility of such combinations can be detected by the present invention.

As shown in the Figures for the purposes of illustration, embodiments of the present invention are exemplified a method and a system for detecting a potentially dangerous condition on a transport vehicle. FIG. 1A is a flow diagram 100 illustrating one embodiment of the present invention.

Referring to FIG. 1A, a flowchart 100 illustrates a method for detecting a potentially dangerous condition on a transport vehicle such as, for example and not limited to, a passenger airplane. In the method, a passenger information database is provided. Step 102. The passenger information database includes passenger data for all the passengers of the airplane. The passenger information database includes a first passenger data record associated with a first passenger. Each data record includes a list of items (the “item list”) associated with a particular passenger. For example, the item list includes description of or information pertaining to items to be carried-on by the passenger on to the airplane, items to be checked-in as baggage for transport in the same airplane, or both type of items. The item list may be a partial list or a comprehensive list. That is, the item list may but need not include all the items to be carried-on or checked-in by the passenger. Each description of an item of the item list is referred to as an “item entry.”

Initially, the item list is empty. That is, the item list includes no item entry. The item list can be populated by obtaining the item entries from the first passenger, from a security officer, or both. Step 104. To populate the item list, the description of items for the item list is obtained from each passenger, for example, the first passenger. There are a number of ways in which the item list can be acquired. For example, the passenger himself can enter the information prior to arriving at an airport to embark on the airplane. Alternatively, the item list can be populated by a security officer (screening the passenger), or both the passenger and the security officer.

The item list is provided to security officer responsible for checking the items of the passenger. Step 106. Likewise, there are a number of ways in which the item list can be provided to the security officer. For example, a copy of the item list (entered by the passenger) can be made and displayed at a display station for the security. This access is typically a computerized interface allowing the security officer to view, add it, edit, and delete items from the item list.

A knowledge base is provided. Step 108. The knowledge base includes transport limitation information for a plurality of items. The knowledge base is discussed in more detail below. Using the knowledge base, transport limitation for each of the items of the item list is determined. Step 110. The transport limitation can be, for example, “carry-on permitted,” “carry-on permitted if less than three ounces,” or “carry-on prohibited.” Finally, the security is notified of the transport limitation determination for each item of the item list. Step 112.

### Populating the Item List

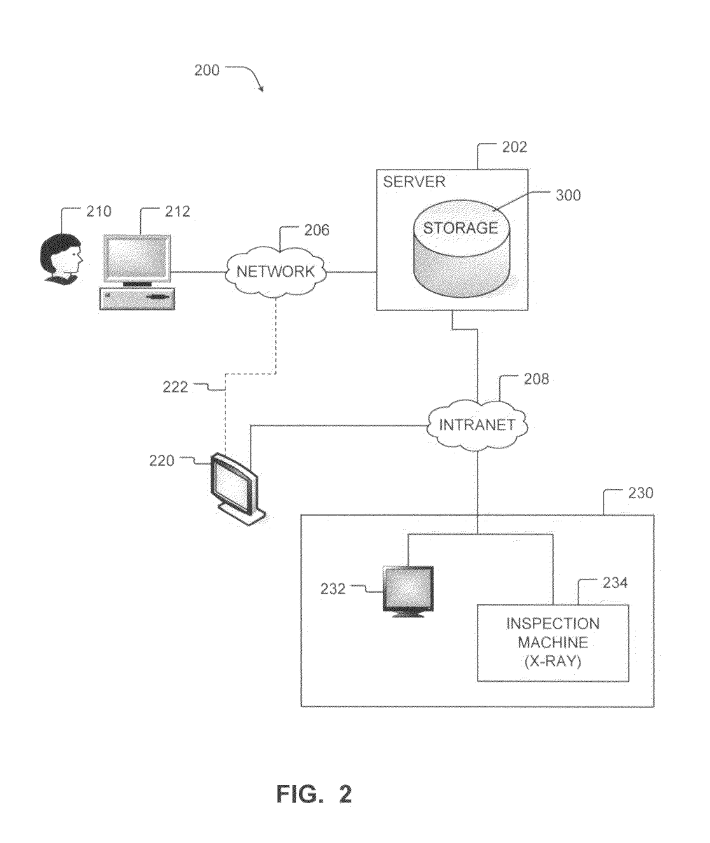

There are a number of ways in which the item list is populated. FIG. 1B is a flow diagram 120 illustrating one embodiment of the present invention. FIG. 2 illustrates a simplified diagram of a system 200 illustrating various aspects of the present invention. Referring to FIGS. 1B and 2, to obtain item entries to populated the item list, a computerized interface is provided, the interface accessible to each passenger, for example the first passenger. Step 122. Via the interface, the passenger is prompted to enter for input descriptions of items that the passenger desires to carry onto the transport vehicle. Step 124. This way, description of at least one item is obtained. Step 126. Then, the item list is formed using the obtained description of the items. Step 128. Each item list has a minimum length of one item. Additional item entries can be entered by the security officer.

While the time the first passenger enters the description of items for the item list, the items can be analyzed to determine transport limitation for the items. Step 130. This determination process us discussed in greater detail below. The determined transport limitation displayed for the first passenger. Step 132.

In addition to these functions, the system 200 provides to the first passenger facilities to perform a number of functions, for example, adding items to the item list, deleting items from the item list, and editing the description of the items of the item list. Step 134.

### The System

Referring to FIGS. 1A through 2, the system 200 includes, in the illustrated sample embodiment, a server computer 202 including data storage 300. The server 202 is connected to an external network 206, for example, the Internet, through which a passenger such as the first passenger 210 can connect to the server 202 using his or her own computer 212.

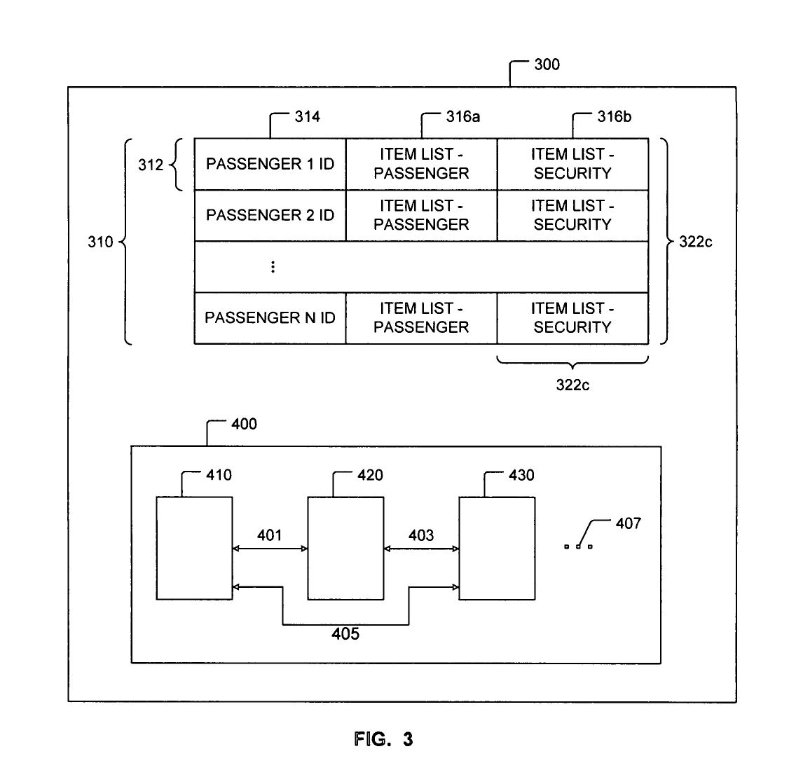

Portions of the storage 300 are illustrated in FIG. 3. Referring to FIG. 3 but also continuing to refer to FIGS. 1A through 2, the storage 300 includes a number of databases. The server 202 provides the passenger information database 310 including a first passenger data record 312 associated with the first passenger 210, the first passenger data record 312 including an item list 316 associated with the first passenger 210. For example, for the first passenger 210, the passenger information database 310 includes the first passenger data record 312 that is associated with the first passenger 210. The first data record 312 includes a first passenger identification code 314, and a passenger item list 316. In some implementations, one item list can be used. In the illustrated embodiment, two item lists are used—a first item list, also referred to as a passenger item list 316a; and a second item list, also referred to as a security item list 316b.

The passenger item list 316a is editable by the first passenger 210, and the security item list 316b is editable by a security officer (not illustrated in the Figures). For convenience, the passenger item list 316a is referred to herein as the “passenger item list 316a”; and the passenger item list 316b is referred to herein as the “security item list 316b.” Generically, the phrase “item list 316” applies to the passenger item list 316a, the security item list 316b, or both, depending on the context. The data storage 300 also includes a knowledge base 400 which is described in more detail below.

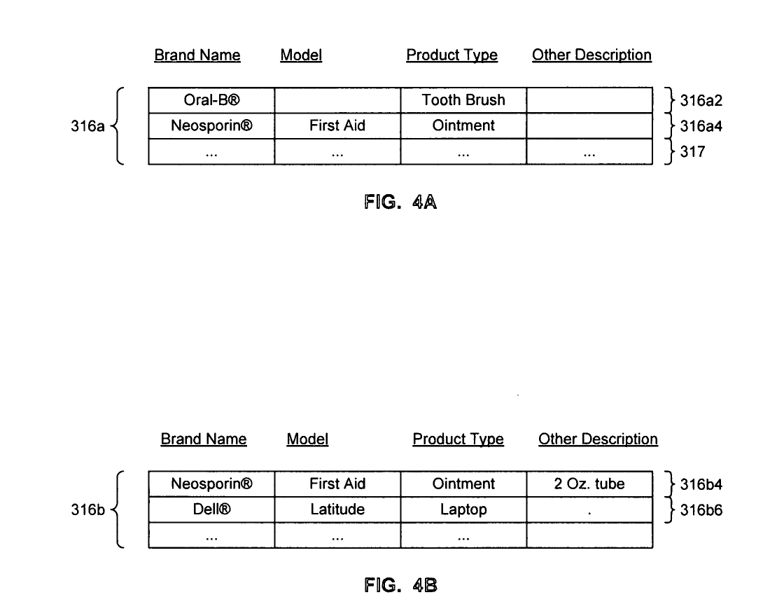

The item lists 316a and 316b are illustrated in more detail as FIGS. 4A and 4B, respectively. The passenger information database 310 is created or exists for each and every flight, a flight defined by a number of factors including, for example only, departure and destination locations, departure and destination times, identification of the transport vehicle, an airplane in the present example, or any combination of these factors. The first data record 312 is created when the first passenger 210 reserves a seat for a particular flight. The first passenger identification code 314 is any information that uniquely identifies the first passenger and the flight, and it may be provided to the first passenger 210 after the creation of the first data record 312.

Referring to FIGS. 1A through 4B inclusive, as illustrated, the passenger item list 316a includes a list of items that the first passenger intends to carry on to the airplane, to check in as a baggage on the airplane, or both. The first passenger 210 is allowed access to the passenger item list 316a to perform various operations such as, for example, to display the items of the passenger item list 316a, add items to the passenger item list 316a, to delete items from the passenger item list 316a, and to edit items of the passenger item list 316a. The first passenger 210 is allowed access to the passenger item list 316a from his computer 212, from a kiosk terminal 220 at an airport or other public places, or both.

In the illustrated example, the passenger item list 316a includes a number of fields (or columns), each field containing a different type of information compared to the other fields of the item list 316a such as the following fields: Brand Name, Model Designation, Product Type, or Other Description. Different implementations of the present invention can include different structure for the item list 316a. Continuing with the illustrated example, the passenger item list 316a includes a toothbrush and Neosporin® First Aid Ointment. The passenger item list 316a may include other items not illustrated as indicated by ellipses entry 317. Again, the item list may be a partial list or a comprehensive list. That is, the passenger item list 316a may but need not include all the items to be carried-on by the passenger. The data structure of each entry of the item list 316a can vary depending on implementation. For example, each entry of the item list 316a can include a number of fields including brand name, size or weight, product type, year made, expiration date, description of the contents, etc. Any or all of these fields can be partially or completely filled by the passenger. Further, each item entry is not required to be complete, but include as much information as available.

The kiosk terminal 220 can be, for example, a public terminal available at the airport that can be used to make final edits to the passenger item list 316a. The terminal 220 can be located at the airport or other public access places. In the illustrated embodiment, the access to the passenger item list 316a is provided using computerized interfaces. The access to the passenger item list 316a is granted until the first passenger 210 arrives at a security check point. Upon creation or editing of the passenger item list 316a, the first passenger 210 is notified of the first passenger 210's identification code 314. The identification code 314 can be printed out or otherwise recorded and brought to the security check point. The kiosk terminal 220 is connected to the server 202 via another network 208 such as an intranet 208 within the airport. Alternatively, the kiosk terminal 220 can be connected to the server 202 via the external network 206—this connection is illustrated as a dashed line 222.

During the time the passenger 210 accesses the passenger item list 316a or at anytime thereafter, the server 202 analyzes the passenger item list 316a to determine the transport limitation of the items of the item list 316a. Then, the passenger 210 is notified that the identified listed carry-on item should not be brought onto the plane. The notification can be implemented as a on-screen warning when the passenger 210 is actively accessing the passenger item list 316a; an email message to the passenger 210; or other appropriate means including, for example only and without limitation, SIMS (Short Message Service) message, an automated telephone call to the passenger 210's telephone, facsimile transmission, even a mailed letter, or any combination of these or other communication methods.

Further, the server 210 analyzes the item list to determine whether or not any combination of items pose danger to the flight or is prohibited as a carry-on item. If it is determined that any combination of items is prohibited as a carry-on item or that any combination of items poses danger to the flight, then the passenger 210 is notified that the identified combination of items should not be brought onto the plane. The method of analyzing the items of the passenger item list 316a, individually and in combination, is described below in more detail.

### Screening the Passenger

When the first passenger 210 arrives at a security station 230 for screening, or some time before the first passenger 210 arrives at the security station 230, the passenger item list 316a is copied onto the security item list 316b. At the security station 230, the passenger 210 presents his identification information (including the passenger identification code 314) and the carry-on items to a security officer for screening.

At the time of the drafting of the present document, the passenger 210 and the carry-on items are typically scanned electronically using X-ray machines or other inspection machines. The scanning machines are generally represented in the Figures by the inspection machine 234. The inspection machine 234 displays the scan results on a display monitor for review by the security officer. Some items such as laptop computers and other electronic items are individually scanned, hand inspected, or both. In some circumstances, all the carry-on items are hand inspected.

For the purposes of the present invention, the method of inspection of the carry-on items is not critical. In the present example, the security officer inspecting the carry-on items or reviewing the display monitor (showing the X-ray or other scan results) is provided access to the security item list 316b via a security terminal 232 connected to the server. The security officer compares the security item list 316b with the carry-on items presented to the security officer by the first passenger 210. If the security officer determines that an item presented to him is not listed in the security item list 316b, the security officer may add the item to the security item list 316b or choose to ignore the item and let it be carried-on by the first passenger 210. In the Figures, this is illustrated with item entry 316b6 which is added to the security item list 316b by the security officer. Additional information can be supplied by the security officer. In the present example, the quantity of the ointment is added by the security officer for Entry 316b4.

If the security officer determines that an item listed in the security item list 316b is not presented to him by the first passenger 210, then the security officer deletes the item form the security item list 316b. In the Figures, this is illustrated with item “toothbrush” 316a2 which exists in the passenger item list 316a but is deleted from the security item list 316b.

During the time the passenger 210 is at the security station, the server 202 analyzes the security item list 316b to determine whether or not any of the listed items pose danger to the flight or is prohibited as a carry-on item. If it is determined that any item is prohibited as a carry-on item or that any item poses danger to the flight, then the security officer is notified that the identified listed carry-on item should not be brought onto the plane. The notification can be implemented as an on-screen warning when the security officer is accessing the security item list 316b.

Further, the server 210 analyzes the security item list 316b to determine the transport limitation for each item. That is, a determination is made on whether or not any item or combination of items pose danger to the flight or is prohibited as a carry-on item. If it is determined that any combination of items is prohibited as a carry-on item or that any combination of items poses danger to the flight, then the security officer is notified that the identified combination of items should not be brought onto the plane. The method of analyzing the items of the item list, individually and in combination, is described below in more detail.

Additionally, the server 210 analyzes the item list 316 of the entire flight, indicated in FIG. 3 with reference number 322c, to determine whether or not any combination of the item listed therein poses danger to the flight or is prohibited as a carry-on item. If it is determined that any combination of items is prohibited as a carry-on item or that any combination of items poses danger to the flight, then the security officer or another security officer is notified that the identified combination of items should not be brought onto the plane. The method of analyzing the items of the item list, individually and in combination, is described below in more detail.

In addition to these functions, the system 200 provides to the security officer facilities to perform a number of functions, for example, adding items to the item list, deleting items from the item list, and editing the description of the items of the item list.

### Analyzing the Item Lists

The data storage 300 also includes a knowledge base 400 including a number of databases, tables, or both that is used to analyze the items and combination of items in the item list 316. As indicated in FIG. 3, the knowledge base 400 includes, without limitation, various tables, databases, and other information structures (generically referred to herein as “table” or “tables”) including information regarding permitted and prohibited items, recalled items, and levels and types of dangers of various items and combination of items. The tables within the knowledge base 400 are indicated by tables 410, 420, and 430 as well as an ellipsis 407. These tables, entries within the tables, or both are associated with or linked to related tables, related entries of other tables, or both. These associations or linkages are illustrated as directional lines 401, 403, and 405. Here, terms “association” and “link” are used interchangeably. Any association can be a bidirectional association or a unidirectional association depending on how the knowledge base 400 is implemented. The tables and the databases of the knowledgebase 400 may be implemented in a number of different logical structures, physical structures, or both and still be within the scope of the present invention.

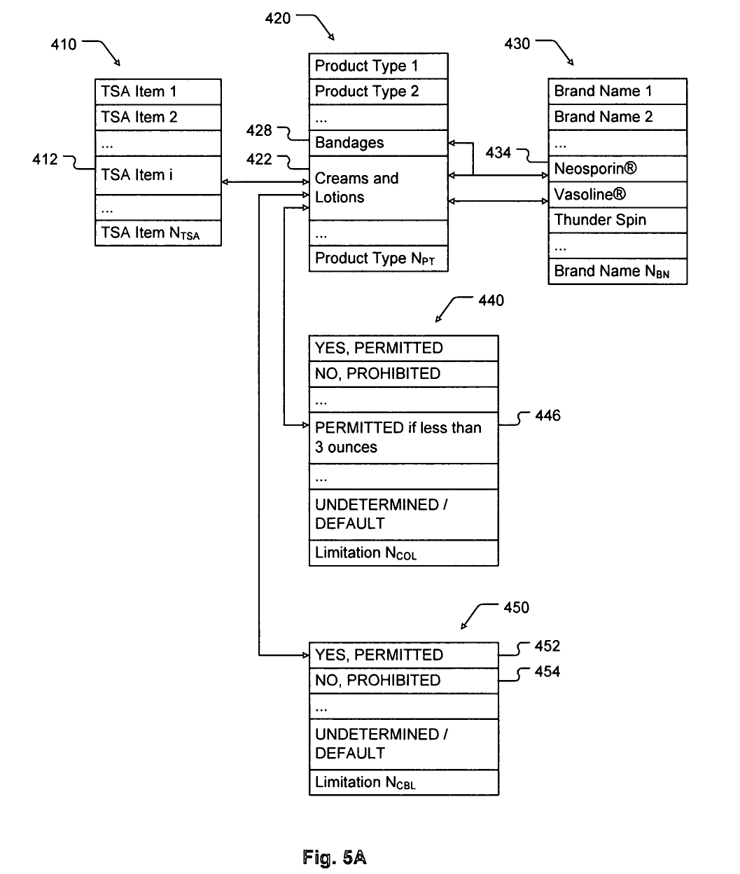

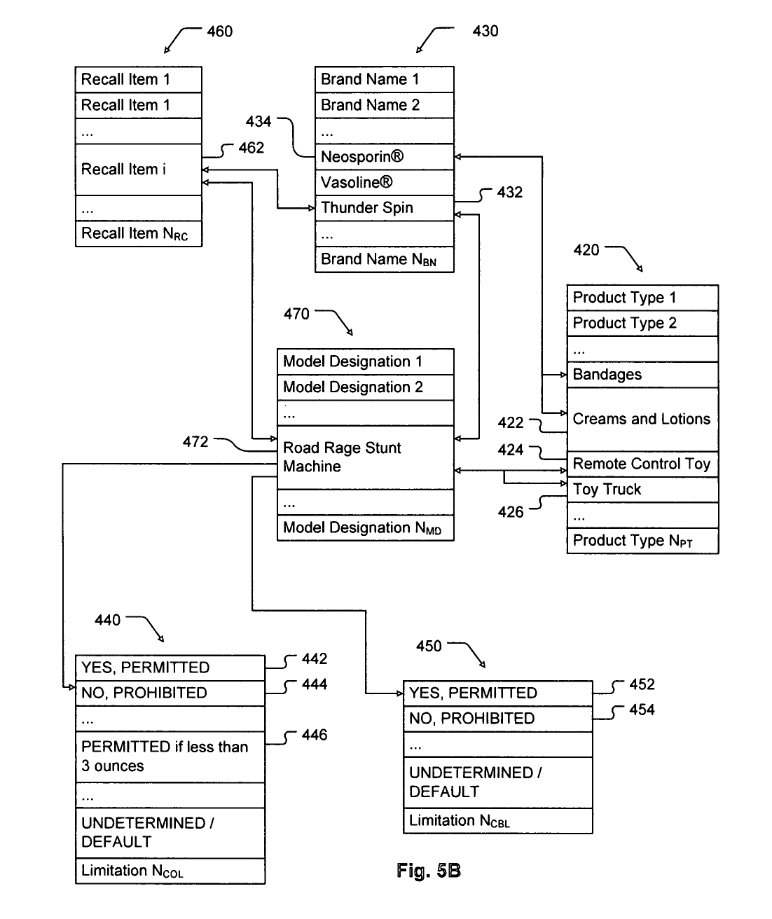

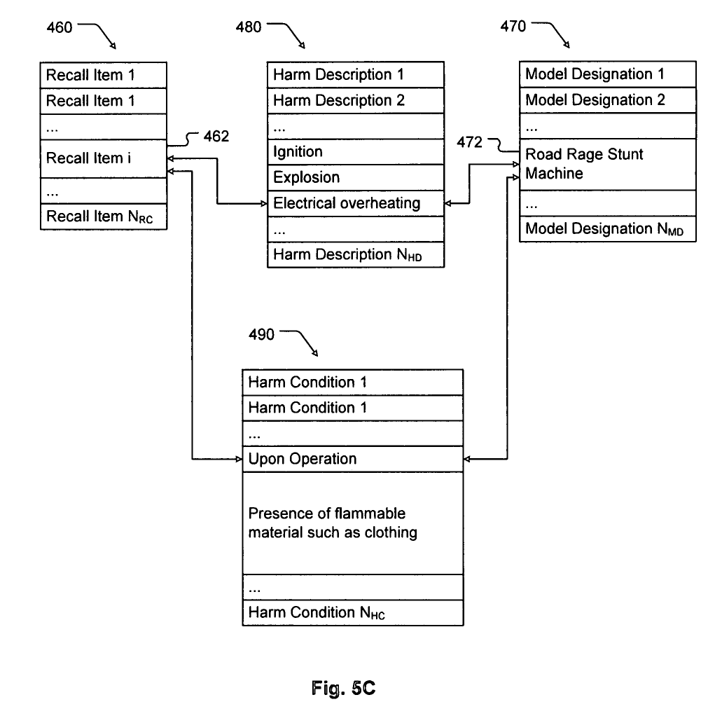

Potions of the knowledge base 400 are illustrated in more detail in FIGS. 5A, 5B, and 5C. Referring to FIGS. 5A through 5C, one sample embodiment of the knowledge base 400 includes, for example and without limitation, a government issued table of permitted and prohibited items 410 (the “TSA table 410”). For example, the Transportation Security Administration (TSA) of the U.S. Department of Homeland Security issues a “Permitted and Prohibited Items” list. Information promulgated by the TSA's Permitted and Prohibited item list is incorporated into the knowledge base 400 as the TSA table 410. In the illustrated embodiment, the TSA table 410 includes a plurality of entries. For example, the TSA table 410 includes Item 412 that indicates creams and locations are allowed to be checked in as luggage, but are limited as a carry-on item depending on the amount or size of the item. For convenience, table or database entries are also referred to as rows. FIGS. 5A through 5C illustrate a number of tables for the purposes of discussing various aspects of the present invention; however, the Figures are not comprehensive illustrations of tables, entries, or associations. In particular, to avoid clutter and for convenience of discussion, not every possible entry and association is illustrated.

The knowledge base 400 can also include, without limitation, a Product Type table 420, a Brand Name table 430, a Carry-on Limitation table 440, and a Checked Baggage Limitation table 450. The Carry-on Limitation table 440 and the Checked Baggage Limitation table 450 include information on transport limitation of items associated with the entries of these tables.

The Product Type table 420 lists product types, the Brand Name table 430 lists Brands, often trademarked brands (indicated by (R) designator). The Carry-on Limitation table 440 indicates the transport limitation information as to whether or not an item is allowed to be carried on to the airplane. The Checked Baggage Limitation table 450 indicates the transport limitation information as to whether or not an item is allowed to be checked-in and shipped by the airplane. Each entry of any and all of these tables may be associated with or linked to entries of other tables.

Each entry of the TSA table 410 identifies items of the TSA's Permitted and Prohibited item list. There are a number of ways that each entry item can be identified, and the carry-on limitations and the checked baggage limitations indicated. In the illustrated embodiment, the entries of the TSA table 410 are associated with entries in other tables. For example, the TSA item i 412 (referred to as TSAᵢ herein) is associated with product type “Creams and Lotions” 422. Product type Creams and Lotions is, in turn, associated with various brand names that represent the source or the manufacturer of Creams and Lotions such as, for example only, Neosporin® and Vaseline®. Again, each of the entries of the tables of the knowledge base 400 may be and is likely to be associated with multiple entries of other tables of the knowledge base 400. This is because, for example, for product type, multiple companies or manufacturers can market items. Likewise, each brand name (representing a company or a manufacturer) may include a plurality of different product types and models.

The entries of the TSA table are also associated with entries in the Carry-on Limitation table 440 and the Checked Baggage Limitation Table 450. Continuing the present example, the product type entry “Creams and Lotions” 422 is associated with an entry in the Carry-on Limitation table 440 that indicates that any item associated with Entry 422 (the Creams and Lotions in the present example) is allowed to be carried on to the airplane if and only if it meets the limitation that the item is in quantity of less than 3 ounces. Also, Entry 422 is associated with an entry in the Checked Baggage Limitation table 450 that indicates that an item associated with Entry 422 is permitted to be checked in as shipped baggage carried by the airplane without further limitations.

Continuing to refer to FIGS. 5A through 5C, the knowledge base 400 (of FIG. 3) includes, in the illustrated sample embodiment, a Recall Items table 460. For example, U.S. Consumer Products Safety Commission releases Recall Alerts that can be integrated or otherwise included in the knowledge base 400 as the Recall Items table 460. Not all recall items are prohibited as a carry-on item or prohibited as a checked baggage on an airplane; however, some may be thusly prohibited. In the illustrated example, Recall Item i, (referred to as Recallᵢ herein) 462 may be a prohibited item as a carry-on. The item Recallᵢ 464 is associated with Brand Name Entry 432 (having value “Thunder Spin”) and Model Designation Entry 472 (having value “Road Rage Stunt Machine”). FIG. 5B illustrates a Model Designation Table 570 having multiple entries, each entry being associated with one or more entries of the other tables of the knowledge base 400.

In the illustrated example, Entry 472 (“Road Rage Stunt Machine”) has a number of associations, some of which are illustrated in the FIG. 5B as following associations: with entry Recallᵢ 462; with brand entry 432; with product entries 424 and 426; and with “Prohibited” entry 444 of the Carry-on Limitation table 440 and the “Permitted” entry 452 of the Checked Baggage Limitation table 450.

Additional tables, table entries, and associations of the entries 462 and 472 are illustrated in FIG. 5C. As illustrated, the entries 462 and 472 may be associated with entries of a Harm Description table 480 and Harm Condition table 490. The Harm Description table 480 includes entries, each entry describing a type of harm posed. The Harm Condition table 490 includes entries, each entry describing the condition under which the harm occurs.

The tables, table entries, and associations between the entries illustrated in FIGS. 5A through 5C are merely sample and partial illustrations of various portions of the knowledge base 400. As illustrated in FIGS. 5A through 5C, the associations of the entries of the knowledge base 400 create a network of associations with the entries of the network being nodes of the network of associations.

### Analyzing the Passenger Item List

Referring again to FIGS. 4A and 4B but also continuing to refer to FIGS. 5A through 5C, to analyze the items of an item list, for example the passenger item list 316a, the following steps are taken: First, for each item of the item list 316a, corresponding entries in the tables is identified. An entry that corresponds to an item of the item list is an entry of a table within the knowledge base 400 that describes one or more characteristic of the item such as, for example, the item's brand name, model designation, product type, description of the material, chemical composition, or in other aspects. For example, for the item “Neosporin® First Aid Ointment” 316a4, corresponding entries includes, without limitation, Entry “Creams and Lotions” 422 of the Product Type table 420 and Entry “Neosporin®” 434 of the Brand Name table 430. The identification can be made, for example, by matching field values of the item list 316 with entries of tables of the knowledge base 400.

To identify the corresponding entry of an item, a number of methods can be used. For example, the item's product type, brand name, model designation can be used to correlate the item to the thread/harm descriptions stored in the knowledge based. Other characteristics can be used such as, for example only, material or chemical composition or other aspects.

For example, if a threat or harm posed by the item is correlated to a recalled product, for instance a recalled laptop battery of certain brand name and model designation, then the product type and brand name and the model designation can be used to identify with a harm/threat description in the knowledge base. Alternately, if the product type of an item provided by a user does not appear to be recognized by the knowledge base, or if the product type of an item is recognized by the knowledge base but the brand name is not recognized, other characteristics of the item such as model designation, product name, description of the material, ingredients of the material, chemical composition or other aspects can be used to correlate the item to the knowledge base.

Then, the associations of the identified entries are traversed to an entry in the Carry-on Limitation table 440 to determine whether or not the item is a permitted or a prohibited item, whether or not any limitations apply, or both. In the present example, the identified entries are Entry 422 and Entry 434. Each of these entries is associated with a number of entries. Entry 422 of the Product Type table 420 is associated with Entry 446 of the Carry-on Limitation table 440. This indicates that item 316a4 is permitted to be carried-on to the airplane if a limitation is met, the limitation being, in this example, that the quantity of the item is three ounces or less. Further, Entry 422 of the Product Type table 420 is associated with Entry 452 of the Checked Baggage Limitation table 450. This indicates that item 316a4 is permitted to be checked in as baggage on to the airplane. At this point, a decision of whether or not the limitation of the reached entry, entry 446 in the current example, is satisfied. That is, a decision is made whether or not the item under analysis is, in this case, less than 3 ounces.

Continuing with the present example, Entry 434 is identified as corresponding to item 316a4 because both of these share the same Brand Name which is, in the present Example, Neoprene®. Entry 434 is not directly associated with an entry within tables 440 and 450. Rather, a traversal of the associations of Entry 434 leads to Entry 422, which, in turn, leads to Entry 446 of the Carry-on Limitation table 440 and Entry 452 of the Check-in Limitation table 450.

Ideally, the identified entry is associated directly with an entry within the Carry-on Limitation table 440 and an entry within the Checked Baggage Limitation table 450. However, if the identified entry is not directly associated with such an entry, the network to which the identified entry belongs to is traversed with the goal of reaching an entry of the Carry-on Limitation table 440 and an entry within the Checked Baggage Limitation table 450.

To traverse a network, it is determined (traversal method step 1), beginning at the identified entry, whether or not the identified entry is associated with an entry of the Carry-on Limitation table 440, an entry within the Checked Baggage Limitation table 450, or both. If yes, then the traversal is complete and the item being analyzed is permitted or prohibited as a carry-on item per the associated entry of the Carry-on Limitation table 440. Likewise, it is determined whether or not the identified entry is associated with an entry of the Checked Baggage Limitation table 450. If yes, then the traversal is complete and the item being analyzed is permitted or prohibited per the associated entry of the Checked Baggage Limitation table 450. Once an entry of the Carry-on Limitation table 440, an entry of the Checked Baggage Limitation table 450, or both is reached, the traversal is complete.

If the identified entry is not associated with an entry of the Carry-on Limitation table 440, or an entry of the Checked Baggage Limitation table 450, then each entry associated with the identified entry is analyzed (traversal method step 2) to determine whether or not the associated entry describes an aspect of to the item under analysis. If the associated entry describes an aspect of to the item under analysis, then the network traversal is reiterated from traversal method step 1. For example, Entry 434 is identified as corresponding to item 316a4 because both of these share the same Brand Name which is, in the present Example, Neoprene®. Entry 434 is not directly associated with an entry within tables 440 and 450. Rather, a traversal of the associations of Entry 434 leads to Entry 428 (“Bandages”) as well as Entry 422 (“Creams and Lotions”). Here, at Entry 428, the traversal of the network is terminated because “Bandages” does not describe an aspect of “Neosporin® First Aid Ointment” of Item 316a4. However, the traversal of the network continues at Entry 428 because “Creams and Lotions” does describe an aspect of “Neosporin® First Aid Ointment” of Item 316a4. As already discussed, this leads to Entry 446 of the Carry-on Limitation table 440 and Entry 452 of the Check-in Limitation table 450. An Entry of the knowledge base 400 describes an aspect of the item entry of the item list 316 when at least one field of the item entry matches the Entry. “An aspect” of an item can be broadly defined to include any property, characteristic, designation, ingredients, mechanical or chemical compositions, etc.

If the identified entry is not associated with an entry of the Carry-on Limitation table 440, then each entry associated with the identified entry is analyzed (traversal method step 2) to determine whether or not the associated entry describes an aspect of the item under analysis. If the associated entry describes an aspect of the item under analysis, then the network traversal is reiterated from traversal method step 1 using the associated entry as the new identified entry. If the associated entry does not describe an aspect of to the item under analysis, then the network traversal is terminated as for that entry. If the network (in which the identified entry is a node) is traversed without reaching one of the entries of the Carry-on Limitation table 440 and one of the entries of the Checked Baggage Limitation table 450, then the results of the analysis “not found.”

Continuing with the present example, for Item 316a4, the following entries can be identified as corresponding entries: Entry 422 (of the Product Type table 420); Entry 434 (of the Brand Name table 430). The network traversal may begin with Entry 422. The network of associations beginning with Entry 422 is traversed. In the present example, Entry 422 is associated with Entry 446 of the Carry-on Limitation table 440. This is illustrated in FIG. 5A. This indicates that item 316a4 is permitted to be carried-on to the airplane if a limitation is met, the limitation being, in this example, that the quantity of the item is three ounces or less. Further, Entry 422 of the Product Type table 420 is associated with Entry 452 of the Checked Baggage Limitation table 450. This is also illustrated in FIG. 5A. This indicates that item 316a4 is permitted to be checked in as baggage on to the airplane. Thus, the traversal is complete and the values of Entries 446 and Entry 452 are returned as the result of the analysis of Item 316a4.

Alternatively, the network traversal may begin with Entry 434. In the present example, Entry 434 is not directly associated with an entry of the Carry-on Limitation table 440 and an entry of the Checked Baggage Limitation table 450. Here, Entry 434 is associated with Entry 422 of the Product Type table 420 and Entry 428 of the same table. Each of these entries is analyzed to determine whether or not the entry describes an aspect of the item under analysis. As for Entry 428, its value of “Bandages” does not describe an aspect of the item under analysis which is, in the present example, Item 316a4 (“Neosporin® First Aid Ointment”). Accordingly, the network traversal is terminated as for Entry 428. As for Entry 434, its value of “Neosporin®” does describe an aspect of the item under analysis which is, in the present example, Item 316a4 (“Neosporin® First Aid Ointment”). Accordingly, the network traversal is reiterated from traversal method step 1 using the associated entry (Entry 434) as the new identified entry. The result of the network traversal using Entry 434 as the identified entry is discussed above.

### Analyzing the Security Item List

Continuing to refer to FIGS. 4A through 5C, to analyze the items of the security item list 316b, each item of the item list 316b is analyzed using the same methods used to analyze each item of the passenger item list 316a.

### Notifying the Passenger or the Security Officer

The transport limitation as to each of the Carry-on items is determined by the entries of the Carry-on Limitation table 440. Once the entry within the Carry-on Limitation table 440 is identified for a particular item of the item list, the transport limitation for that item is determined as the value of the found entry. For example, for the item 316a4 (“Neosporin® First Aid Ointment”), Entry 446 (“PERMITTED if less than 3 ounces”) of the Carry-on Limitation table 440 was identified as a transport limitation. This information is displayed on the monitor of the computer 212 for the passenger 210, on the kiosk terminal 220 for the passenger, and security terminal 232 for the security officer. Likewise, once the entry within the Checked Baggage Limitation table 450 is identified for a particular item of the item list, the transport limitation for that item is determined as the value of the found entry. For example, for the item 316a4, Entry 452 (“PERMITTED”) of the Checked Baggage Limitation table 450 was identified as a transport limitation. This information is displayed on the monitor of the computer 212 for the passenger 210, on the kiosk terminal 220 for the passenger, and security terminal 232 for the security officer. Notification can take a number of forms such as, for example only, an on-screen notation, flashing characters or icons on screen, text or other types of messages to communications devices, email messages, etc.

### CONCLUSION

From the foregoing, it will be appreciated that the present invention is novel and offers advantages over the current art. Although a specific embodiment of the invention is described and illustrated above, the invention is not to be limited to the specific forms or arrangements of parts so described and illustrated. For example, differing configurations, sizes, or materials may be used to practice the present invention. The invention is limited by the claims that follow.

What is claimed is:

1. A method for screening items for transport, the method comprising:
providing a passenger information database including a first passenger data record associated with the first passenger, the first passenger data record including an item list;
populating the item list by obtaining, from the first passenger, a list of items for transport;
providing access to the list of items to security officer;
providing a knowledge base having transport limitation for a plurality of items;
determining, using the knowledge base, for each item of the list of items, transport limitation of the item; and
notifying the security officer with the item transport limitation.

2. The method recited in claim 1 wherein:
the item list is a passenger item list;
the step of determining the transport limitation is performed while the passenger is updating the passenger item list; and
further comprising a step of notifying the passenger with the item transport limitation.

3. The method recited in claim 1:
wherein the item list is copied onto a security item list;
further comprising the step of providing facilities for the security officer to perform functions on the security item list such as at least one of adding to, editing of, and deleting from the security item list; and
wherein the step of determining the transport limitation is performed using the security item list.

4. The method recited in claim 1 further comprising:
the steps of providing facilities for the passenger to perform functions on the item list such as at least one of adding to, editing of, and deleting from the security item list.

5. The method recited in claim 1 wherein the knowledge base comprises
a plurality of tables, each table having a plurality of entries;
wherein,
at least one table having at least one entry corresponding to at least one aspect of an item of the item list; and
entries of the tables of the knowledge base having associations with entries of other tables of the knowledge base, the associations forming a network of associations.

6. The method recited in claim 5 wherein the step of determining transport limitation of the item comprises:
searching the knowledge base to identify at least one entry in the knowledge base that corresponds to at least one aspect of the item;
traversing the network of associations beginning at the identified entry until an entry in a limitation table is reached, where the limitation table is at least one of Carry-on Limitation Table and Checked Baggage Limitation Table; and
deciding whether or not limitation of the reached entry of the limitation table is satisfied.

7. The method recited in claim 1 wherein the step of obtaining the list of items comprises a step of providing a computerized interface available for a first passenger, the computerized interface allowing the first passenger officer to perform at least one of the following functions: add items, deleted items, and edit items.

8. The method recited in claim 1 wherein the step of obtaining the list of items comprises a step of providing a computerized interface available for a security officer, the computerized interface allowing the security officer to perform at least one of the following functions: add items, deleted items, and edit items.

9. The method recited in claim 1 wherein the step of obtaining the list of items comprises maintaining an items database comprising multiple data tables, a first data table including a list of items editable by the first passenger and a second data table editable by a security officer.

10. A system for screening items for transport, the system comprising:
a server including storage, the storing having
a passenger information database including a first passenger data record associated with the first passenger, the first passenger data record including an item list;
a knowledge base having transport limitation for a plurality of items;
a security station for screening the first passenger, said security station connected to said server; and
wherein
the item list is populated with a list of item for transport for the first passenger; and
the server is connected to an external network thereby allowing access to its passenger information database to the first passenger, also connected to the external network.

11. The system recited in claim 10 further comprising:
a kiosk terminal connected to said server, said kiosk terminal allowing the first passenger to access the item list.

12. The system recited in claim 10 wherein
the knowledge base comprises a plurality of tables, each table having a plurality of entries;
at least one table having at least one entry corresponding to at least one aspect of an item of the item list;
entries of the tables of the knowledge base having associations with entries of other tables of the knowledge base, the associations forming a network of associations;
the knowledge base includes a limitation table, where the limitation table is at least one of Carry-on Limitation Table and Checked Baggage Limitation Table.

13. The system recited in claim 10 wherein the passenger information database comprises multiple data tables, a first data table including a list of items editable by the first passenger and a second data table editable by a security officer.

14. A method for screening items for transport, the method comprising:
providing a computerized interface to a first passenger;
prompting, via the computerized interface, for input of items that the first passenger desires to carry onto the transport vehicle;
obtaining description of at least one item;
forming a list of items, the list including descriptions of the obtained items;
determining, for each obtained item, transport limitation;
displaying, for each obtained item, the determined item transport limitation; and
allowing the first passenger to perform, on the list of items, at least one of the following functions: add item, deleted item, and edit item.

15. The method recited in claim 14 wherein:
the item list is a passenger item list; and
the step of determining the transport limitation is performed while the passenger is updating the passenger item list.

16. The method recited in claim 14:
wherein the item list is copied onto a security item list;
further comprising the step of providing facilities for the security officer to perform functions on the security item list such as at least one of adding to, editing of, and deleting from the security item list; and
wherein the step of determining the transport limitation is performed using the security item list.

17. The method recited in claim 14 wherein the knowledge base comprises
a plurality of tables, each table having a plurality of entries;
wherein,
at least one table having at least one entry corresponding to at least one aspect of an item of the item list; and
entries of the tables of the knowledge base having associations with entries of other tables of the knowledge base, the associations forming a network of associations.

18. The method recited in claim 17 wherein the step of determining transport limitation of the item comprises:
searching the knowledge base to identify at least one entry in the knowledge base that corresponds to at least one aspect of the item;
traversing the network of associations beginning at the identified entry until an entry in a limitation table is reached, where the limitation table is at least one of Carry-on Limitation Table and Checked Baggage Limitation Table; and
deciding whether or not limitation of the reached entry of the limitation table is satisfied.

19. The method recited in claim 14 wherein the step of obtaining the list of items comprises maintaining an items database comprising multiple data tables, a first data table including a list of items editable by the first passenger and a second data table editable by a security officer.
